(19) United States
(12) Patent Application Publication
(10) Pub. No.: US 2006/0197253 A1
(43) Pub. Date: Sep. 7, 2006

(54) Process for preparing poly(trimethylene terephthalate) staple fibers for conversion into carpets

(76) Inventors: Hoe Hin Chuah, Houston, TX (US); Jerry Wayne Secrist, Houston, TX (US)

Correspondence Address: SHELL OIL COMPANY, P O BOX 2463, HOUSTON, TX, 772522463, US

(21) Appl. No.: 11/366,641

(22) Filed: Mar. 2, 2006

Related U.S. Application Data
(63) Continuation-in-part of application No. 10/400,317, filed on Mar. 27, 2003, now abandoned.

(51) Int. Cl. B29C 47/88

(52) U.S. Cl. 264/211.14; 264/211.22

(57) ABSTRACT

This invention is a process for the production of staple fibers from poly(trimethylene terephthalate) for conversion into carpets which comprises: (a) extruding poly(trimethylene terephthalate) at a melt temperature of 240 to 280° C. into round, trilobal, delta, multi-lobal, or hollow cross section staple fiber tow, (b) quenching the fiber tow such that the undrawn filament tow has a crystallinity of ≦25%, preferably ≦20%, (c) prior to drawing, heating the fiber tow to temperature of 35° C. to 65° C., preferably between 35 and 55° C., to control crystallization, and (d) drawing the staple fiber tow into staple fibers.

This application is a continuation-in-part and claims the benefit of priority of co-pending application U.S. Ser. No. 10/400,317 filed Mar. 27, 2003.

### FIELD OF THE INVENTION

This invention relates to the production of carpets from staple fiber made from poly(trimethylene terephthalate).

### BACKGROUND OF THE INVENTION

Carpet is generally constructed from the following components: the face yarn, which can be cut pile, loop pile, or a combination of the two and is formed from natural or synthetic fibers, a primary backing, a binding compound such as latex, and often a secondary backing. Synthetic fibers for use in carpet and other uses are formed by a process in which molten polymer is forced through tiny holes, or extruded, through a metal plate, or spinneret. After the filaments emerge from the spinneret, they are cooled, drawn, and texturized. Synthetic fibers can be extruded in different shapes or cross sections, such as round, trilobal, pentalobal, octalobal, or square, depending on the design and shape of the spinneret holes.

Carpet is generally made from either bulked continuous filament (BCF) or from staple fiber. BCF is continuous strands of synthetic fiber formed into yarn bundles. If a BCF yarn is desired, the extruded product containing the proper number of filaments for the desired yarn denier is wound directly. Staple fiber is short lengths of fibers which are cut from filaments (as opposed to BCF which is continuous filament). Staple fibers may be converted into spun yarns by textile yarn spinning processes and this generally requires three critical preparation steps—blending, carding, and drafting—prior to the spinning process.

U.S. Pat. Nos. 5,645,782, 5,662,980, and 6,242,091 describe a method for preparing BCF carpet yarn from poly(trimethylene terephthalate) by drawing the fiber from above its glass transition temperature to 200° C. using a draw assist such as hot pin or steam. A different method for preparing BCF yarns for making carpets is described in EP 0,745,711, U.S. Pat. Nos. 6,113,825, 6,254,961, and 6,315,934 using a two-stage draw. In U.S. Pat. No. 6,109,015, poly(trimethylene terephthalate) BCF yarn was prepared by heating the yarn to a temperature between its glass transition temperature and its crystallization temperature. The above methods involve extruding PTT into continuous filaments and then drawing the filaments on a set of feed rolls before using them to make carpet fibers.

Staple fibers have different properties than BCF fibers. Each has its advantages. Staple fiber, when constructed into a higher face weight carpet of >32 oz/yd², has the advantage of giving a more luxurious look and feel than BCF carpets of comparable face weight. Other synthetic or natural staple fibers, such as poly(ethylene terephthalate), nylon, acrylic, polypropylene, silk, wool and cotton, can be blended with poly(trimethylene terephthalate) staple fibers to enhance carpet appearance, wear performance, and dyeing properties. These other fibers cannot be easily blended with BCF yarns. Therefore, it would be useful to be able to prepare staple fiber carpet yarn from poly(trimethylene terephthalate). The present invention provides a method to do so.

### SUMMARY OF THE INVENTION

In one aspect, the present invention is directed to a process for the production of staple fibers from poly(trimethylene terephthalate) for conversion into carpets which comprises:

(a) extruding poly(trimethylene terephthalate) at a melt temperature of 240 to 280° C. into a fiber tow formed of fiber filaments having an undrawn filament denier of at least 25 denier,

(b) quenching the fiber tow such that the fiber tow has a crystallinity of less than or equal to 25%,

(c) prior to drawing, heating the fiber tow to temperature of 35° C. to 65° C.,

(d) drawing the fiber tow, and

(e) forming staple fibers from the drawn fiber tow.

### BRIEF DESCRIPTION OF THE DRAWING

FIG. 1 is a plot comparing the crystallization half time of poly(trimethylene terephthalate) and polyethylene terephthalate measured with a differential scanning calorimeter.

FIG. 2 is a typical differential scanning calorimeter scan of extruded poly(trimethylene terephthalate) filaments prior to drawing.

### DETAILED DESCRIPTION OF THE INVENTION

The staple fiber preparation process of this invention is designed specifically for poly(trimethylene terephthalate), the product of the condensation polymerization of 1,3-propane diol and a terephthalic acid or ester thereof, such as terephthalic acid or dimethyl terephthalate. The poly(trimethylene terephthalate) may be derived from minor amounts of other monomers such as ethane diol and butane diol as well as minor amounts of other diacids or diesters such as isophthalic acid. Poly(trimethylene terephthalate) having an intrisic viscosity (i.v.) within the range of 0.8 to 1.1 dl/g, preferably 0.86 to 0.96 dl/g (as measured in a 50/50 mixture of methylene chloride and trifluoroacetic acid at 30° C.) and a melting point within the range of about 215 to about 235° C. is particularly suitable. It is preferred that the moisture content of the poly(trimethylene terephthalate) be less than 0.005 percent prior to extrusion. Such a moisture level can be achieved by, for example, drying polymer pellets in a drier at 110 to 180° C. with dehumidified air until the desired dryness has been achieved.

The poly(trimethylene terephthalate) is extruded through a spinneret into a plurality of continuous filaments at a temperature within the range of 240 to 280° C., preferably 250 to 270° C., and then cooled rapidly, preferably by contact with cold air, and then the tows are combined for drawing, crimping, and cutting into staple fibers. A spinneret is a metal disc containing numerous minute holes used in manufactured fiber extrusion. The melted polymer is forced through the holes to form the fiber filaments.

The fiber filaments have a denier prior to drawing the fiber filaments such that the fiber filaments may be drawn and formed into staple fibers useful for the preparation of carpets. The undrawn fiber filaments may have a denier of at least 25 denier, or at least 35 denier, or at least 45 denier, or at least 55 denier, or at least 65 denier. In an embodiment the undrawn fiber filaments have a denier of from 25 denier to 65 denier, or from 35 denier to 55 denier.

Directly after emerging from the spinneret, the fiber tow formed of the fiber filaments is quenched at a temperature of 14 to 25° C., preferably from 14 to 20° C. Preferred quenching methods include contact with cross-flow, inwards, or outwards radial-flow cold air. The flow rate of the cold air may range from 0.3 to 1.2 meters per second depending on the extrusion melt temperature, the number of extruded filaments, and the methods of cooling the filaments.

If the fiber tow is heated in a hot spin finish emulsion or hot water dip bath, the temperature of the emulsion or bath should be less than 50° C. in order to achieve the goal of controlling the crystallization which is discussed in more detail below. The emulsion or bath temperature is chosen such that the fiber tow does not crystallize significantly so that it becomes brittle for drawing. Usually this can be visually observed by a change in the fiber tow from translucent to opaque in undelustered PTT fibers. The opaque fiber tow will become too brittle for drawing.

In a process where the fiber tow does not go through a dip bath but instead is put through a series of rolls with hot water or spin finish emulsion sprays, the temperature of the spray should be less than 90° C. The spray temperature chosen will also depend on the number of sprays and the speed of the rolls. The temperature must be chosen such that the fiber tow is not cold crystallized and does not become brittle when it reaches the last roll prior to drawing.

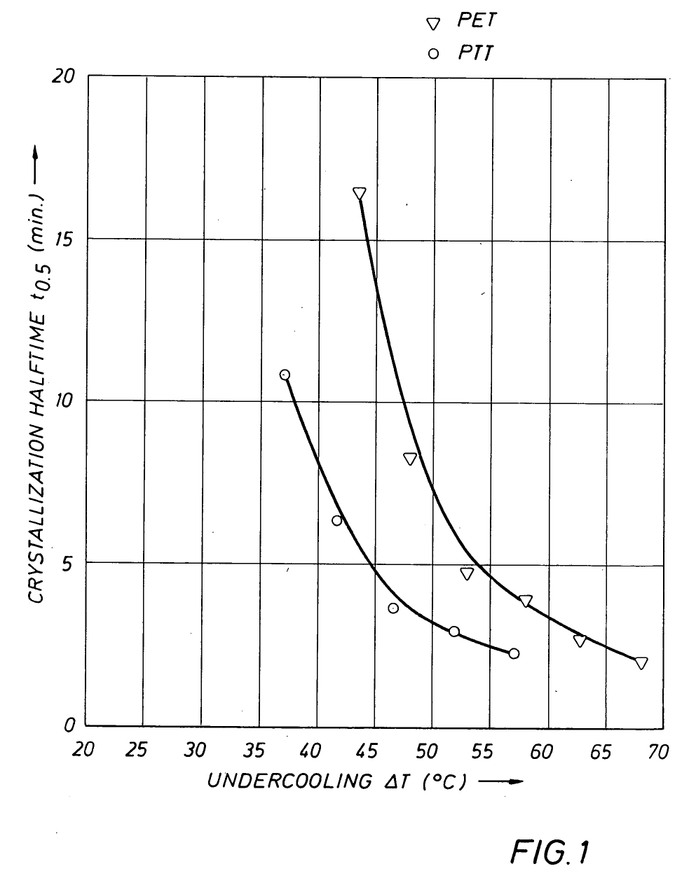

Unlike poly(ethylene terephthalate), poly(trimethylene terephthalate) has a very fast crystallization rate. FIG. 1 compares the crystallization half time, t_{1/2}, of the two polymers measured with a differential scanning calorimeter at different degrees of undercooling. The undercooling temperature is defined as the difference between the polymer's equilibrium melting point and the crystallization temperature. The equilibrium melting points of poly(ethylene terephthalate) and poly(trimethylene terephthalate) are 285° C. and 242° C., respectively. t_{1/2} is the time required to reach 50 percent of the equilibrium crystallinity when the polymer is crystallized at a constant temperature. The lower the t_{1/2} is, the faster the crystallization rate. Because of the very fast crystallization rate of poly(trimethylene terephthalate), the crystallinity of the extruded filaments should be controlled. The consequence of fast crystallization, if not properly controlled, will render the poly(trimethylene terephthalate) spun fiber tow difficult or impossible to draw into fibers. Even though poly(trimethylene terephthalate) is an aromatic polyester, it cannot be processed into staple fiber like poly(ethylene terephthalate) polyester because of the fast crystallization rate. The extruded poly(trimethylene terephthalate) filaments, prior to drawing, should have a crystallinity of less than or equal to 25%, preferably less than or equal to 20%.

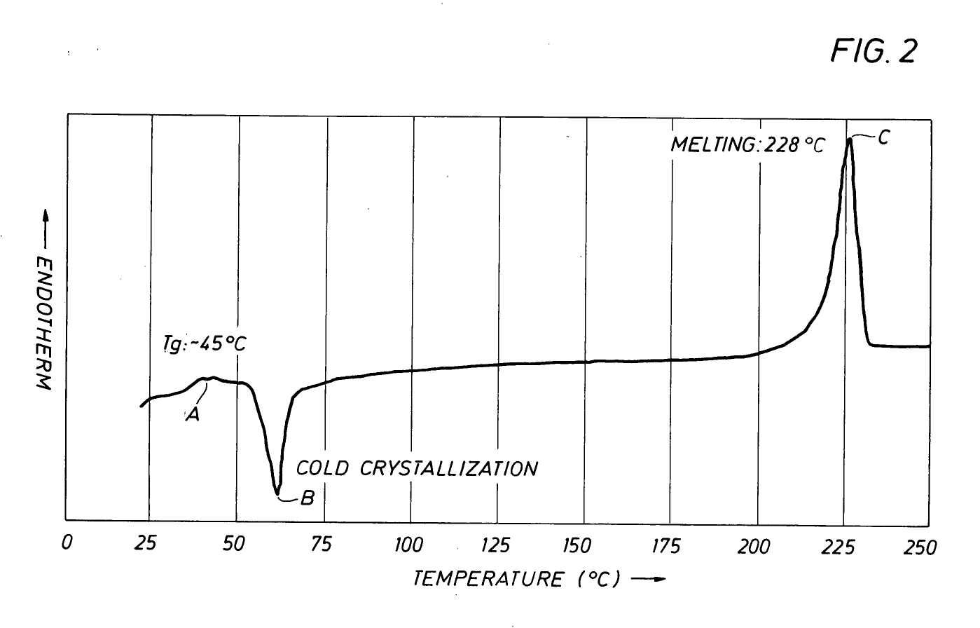

Crystallinity of poly(trimethylene terephthalate) is measured herein by using a differential scanning calorimeter (DSC) at a heating rate of 20° C./min. The DSC scan of the extruded poly(trimethylene terephthalate) filaments should contain the following thermal features shown in FIG. 2. The features are (i) a glass transition temperature, A, of 35 to 55° C.; (ii) a cold crystallization exotherm, B, of 50 to 80° C. (the peak temperature of exotherm B should always be greater than the glass transition temperature A by 5 to 35° C.); (iii) a heat of fusion of 1 to 30 cal/g; and (iv) an endotherm, C, with peak melting temperature of 220 to 235° C.

Crystallinity is defined by the following equation:
% Crystallinity=(ΔH_{c}−ΔH_{B})×100%/ΔH_{f}
where

ΔH_{c}=Heat of fusion of endotherm C in cal/g

ΔH_{B}=Heat of fusion of exotherm B in cal/g

ΔH_{f}=Heat of fusion of 100% crystalline

poly(trimethylene terephthalate), and is reported by Gonzalez et al. in Journal of Polymer Science: Part B: Polymer Physics, Volume 26, pages 1397-1408, 1988, which is herein incorporated by reference, as 35±4 cal/g. Other methods for measuring crystallinity such as density, wide-angle X-ray diffraction, etc. may be used in lieu of the DSC method. Failure to control cold crystallization during processing of poly(trimethylene terephthalate) into staple fiber will cause the extruded filaments to become too brittle and will either result in excessive fiber breaks in the draw frame or the polymer will become impossible to draw into fibers at all.

The extruded poly(trimethylene terephthalate) filaments with controlled crystallinity can either be wound up into fiber packages or laid as loose tow of fibers in a tow can for subsequent drawing, crimping and cutting into staple fibers as a separate processing step, or the extruded filaments can be drawn, crimped, and cut into staple fibers as a continuous process.

In this invention, the preferred drawing temperature of poly(trimethylene terephthalate) ranges from 35° C. to 75° C. This can be achieved by either dipping the fiber tow in a water bath or by heating with hot godet. Typically, 0.2 to 2% by weight of lubricant is applied to the fibers to facilitate drawing. The lubricant can be applied in an emulsified form in the water bath or sprayed onto the filament tow before or after the first heated godet. Suitable lubricants include fatty esters, polyether copolymers which have an ethylene-oxide and/or propylene-oxide unit, nonionic surfactants including propylene-oxide and ethylene-oxide surfactants, and ionic surfactants such as sulfonic acid salts, phosphoric acid ester salts, and high molecular weight fatty acid salts.

The preheated fiber tows may then be fed to at least one set of pre-draw rolls, preferably at a temperature of 50 to 85° C., and preferably drawn at a draw ratio of 2.8 to 4.0. The drawn fiber tows may have a drawn filament denier of at least 10, or from 10 denier to 30 denier, preferably from 15 denier to 25 denier.

Next, the drawn tow can be further heated and then fed to a crimper roll which is operated at a pressure of 2 to 4 bar. Crimping is the process of imparting crimp to the fiber tow. This is important because it provides bulk to the staple fibers. It may be accomplished with the aid of steam or hot air at 120 to 200° C.

The fiber tows are next dried using conventional means, such as a hot air tunnel dryer operated at 130 to 180° C. Finally, the staple fiber is cut into short lengths, such as 1.5 to 10 inches, preferably 4 to 8 inches, and then baled. This is a common shipping and storage package into which these fibers are compressed.

### EXAMPLES

### Example 1

500 lbs. Of poly(trimethylene terephthalate) polymer (PTT) pellets dried to a moisture level of <0.005% were extruded at 250° C. without drawing into a 56 denier per filament (dpf) unoriented yarns with 497 filaments and wound into packages. Forty-five packages of the of the extruded yarns were then combined for drawing, crimping, and cutting into staple fibers with a Neumag staple fiber line, Model 3466. The yarns first passed through a hot spin finish dip bath at 38° C. The spin finish used was 20% Lurol 6023 emulsion from G. A. Goulston Company. The final spin finish level on the fibers was 0.5 to 0.7% by weight. The yarns coated with spin finish were then fed into a series of pre-draw rolls at 77° C. and at a speed of 400 m/min., and drawn at a draw ratio of 3.43. When the spin finish dip bath temperature was >55° C., the filament crystallized in situ in the bath, turned opaque, caused excessive filament break in the drawing process, and reduced the draw ratio. When the filaments were allowed to further crystallize by prolonging the residence time in the bath or raising the bath temperature, they became too brittle and could not be drawn at all.

The drawn yarns were further heated with 70 psi steam prior to crimping. The crimper roll was operated at 3.1 bar and the crimper box pressure was 1.85 bar. The yarns were crimped with 12 crimps/inch with the aid of steam at 132° C. They were then dried at 130° C. in a 40 foot long hot air drying tunnel and cut into 7 inch long staple and baled.

### Example 2

6000 lbs. of PTT staple fibers delustered with 0.1% TiO₂ were made on a staple fiber line Neumag Model 3466. The dried polymer was first extruded into unoriented spun yarn with 41 dpf and a total of 483 filaments and collected as a fiber tow in a tow can. After relaxing in the tow can overnight, the fiber shrunk by about 20% and gave unoriented yarn with 54 dpf. The crystallinity of the yarn, measured by a differential scanning calorimeter (DSC), was 18%. The DSC showed a cold crystallization peak temperature of 67.5° C. and a glass transition temperature of 44° C. Fifty-seven tows of the spun yarns were combined for drawing, crimping, and cutting into staple fibers. The combined tows were passed through a hot spin finish (20% Milube 5494 from G. A. Goulston Company) dip bath at 37° C. The final spin finish on the fibers was 0.2 to 0.5%. The yarns were then fed into a series of pre-draw rolls at about 57° C. and drawn at 400 m/min. to a draw ratio of 3.6. The drawn yarns were further heated with 70 psi steam prior to crimping on a crimper roll operated at 3.1 bar and crimper box pressure of 4.2 bar. The yarns were crimped with 10 crimps/inch with aid of steam at 132° C. They were then dried at 160° C. in a 40-foot long hot air drying tunnel and passed through a finish bath (20% Milube NA29 from G. A. Goulston Company). The final finish on yarn was 1.9%. The yarn was then cut into 7 inch staple fiber and baled.

Properties of the Staple Fiber

| | |
|---|---|
| Denier per filament | 17.5 |
| Crimps per inch | 10.5 |
| Tenacity (g/den.) | 2.1 |
| Elongation, % | 82% |
| Fiber cross-section | Trilobal with 1.5 Modification ratio |

### Example 3

Making PTT Staple Carpets

A 100 lb. of the PTT staple fiber bale of Example 1 was opened, carded, and spun into staple yarns in a typical stable spinning process. Two plies of the yarns were then twisted into 5.25×5.0 twists/inch yarn with 3.75 cotton count. The yarns were heat set in a Suessen heat setter at 185° C. They were tufted into ⅛ inch gauge 24 oz. and 30 oz. staple carpets with 9/16 inch pile height. The PTT staple carpets were dyed with disperse dyes at atmospheric boil without using a carrier.

Accelerated Floor Trafficking Test of PTT Staple Carpets

Specimens 9″×22″ were cut from both the length and width direction and fastened to the floor with the 22″ width perpendicular to the traffic flow. Pedestrians walked in fifty minute intervals. All specimens were vacuumed every hour before traffic was resumed. Multiple electronic counters were used to determine when the predetermined amount (20,000 cycles) of traffic had been applied. At the test's conclusion all specimens were vacuumed before removal from the floor with the last pass of the vacuum in the direction of the original pile. All specimens were allowed to recover at room temperature a minimum of 24 hours before grading by a panel of technicians. Specimens were individually rated using the Carpet and Rug Institute Reference Scale in which the samples are compared to pre-existing reference samples. Ratings were averaged and reported. The higher the rating is the better the expected performance is. The rating scales described the appearance change of the tested product.

Rating:
5—No change
4—Slight change
3—Moderate change
2—Significant
1—Severe change

The accelerated floor trafficking test is one that is commonly used in the industry as a good representation as to how the carpet resiliency would perform in service. A rating of at least 3 is required for the carpet mill to guarantee the product.

Accelerated Floor Trafficking Results

| Carpets | Rating |
|---|---|
| 24 oz. PTT staple carpet | 4.5 |
| 30 oz. PTT staple carpet | 4.0 |

### Example 4

Preparation of PTT Carpets

PTT staple fibers from Example 2 were opened and 1.5% Goulston LPS400 lubricant and 3.5% water was applied to the fibers for carding. Sliver weight from the card was 700 g/yd. Drafting was done in three steps. Six slivers were used in the first and second drafts and three slivers were used for final drafting to give a sliver weight of 70 g/yd. They were then ring spun with a spindle speed of 4,500 rpm and twisted into yarn with 3.25 cotton count and 4.25 twist per inch. The yarns were Suessen heat set at 175° C., tufted into carpets with 32, 40, 50 and 60 oz./yd2 face weight, and dyed with disperse dye at atmospheric boil. The carpets had good bulk and excellent hand by touch compared to commercially available PET staple carpets.

We claim:

1. A process for the production of staple fibers from poly(trimethylene terephthalate) for conversion into carpets which comprises:
(a) extruding poly(trimethylene terephthalate) at a melt temperature of 240 to 280° C. into a fiber tow formed of fiber filaments, the fiber tow prior to drawing being an undrawn fiber tow having a undrawn filament denier of at least 25,
(b) quenching the undrawn fiber tow such that the undrawn fiber tow has a crystallinity of less than or equal to 25%,
(c) prior to drawing, heating the undrawn fiber tow to temperature of 35° C. to 65° C.,
(d) drawing the fiber tow, and
(e) forming staple fibers from the drawn fiber tow.

2. The process of claim 1 wherein the melt temperature in step (a) is from 250 to 270° C.

3. The process of claim 1 wherein the poly(trimethylene terephthalate) is extruded into round, trilobal, delta, multi-lobed, or hollow cross section fiber tow.

4. The process of claim 1 wherein the undrawn fiber tow is quenched such that it has a crystallinity of less than or equal to 20 percent.

5. The process of claim 4 wherein the undrawn fiber tow is quenched such that it has a crystallinity of 12 to 20 percent.

6. The process of claim 5 wherein the undrawn fiber tow is quenched such that it has a crystallinity of 14 to 18 percent.

7. The process of claim 1 wherein the undrawn fiber tow is quenched with cold air at a temperature of 14 to 25° C. and wherein the air has a relative humidity of 50 to 95 percent.

8. The process of claim 7 wherein the temperature of the cold air is from 14 to 20° C.

9. The process of claim 7 wherein the flow rate of the cold air is from 0.3 to 1.2 meters per second.

10. The process of claim 1 wherein the undrawn fiber tow is heated in step (c) to a temperature of from 35 to 55° C.

11. The process of claim 1 wherein the temperature to which the undrawn fiber tow is heated in step (c) is greater than the glass transition temperature of the poly(trimethylene terephthalate) and less than the cold crystallization of the poly(trimethylene terephthalate).

12. The process of claim 10 wherein step (c) is carried out by heating the undrawn fiber tow in a hot spin finish emulsion or hot water dip bath which is at a temperature of less than 50° C.

13. The process of claim 1 wherein step (c) is carried out by putting the undrawn fiber tow through a series of rolls with hot water or spin finish emulsion sprays and the temperature of the sprays is less than 90° C.

14. The process of claim 1 wherein the drawing of the fiber tow in step (d) is carried out at a temperature of from 35 to 75° C.

15. The process of claim 14 wherein the heated fiber tow from step (c) is fed to at least one set of pre-draw rolls that are at a temperature of 50 to 85° C. and then the fiber tow is drawn at a draw ratio of 2.8 to 4.0.

16. The process of claim 1 wherein the drawn fiber tow is heated and then fed to a crimping roll which is operated at a pressure of 2 to 4 bar prior to forming staple fibers from the drawn fiber tow.

17. The process of claim 16 wherein the crimping is accomplished with the aid of steam or hot air at 120 to 200° C.

18. A process for the production of staple fibers from poly(trimethylene terephthalate) for conversion into carpets which comprises:
(a) extruding poly(trimethylene terephthalate) at a melt temperature of 240 to 280° C. into a fiber tow formed of fiber filaments,
(b) quenching the fiber tow such that the fiber tow has a crystallinity of less than or equal to 25%,
(c) prior to drawing, heating the fiber tow to temperature of 35° C. to 65° C.,
(d) drawing the fiber tow, where the drawn fiber tow is comprised of drawn filaments having a denier of at least 10, and
(e) forming staple fibers from the drawn fiber tow.
